(19) United States
(12) Patent Application Publication
(10) Pub. No.: US 2009/0039890 A1
(43) Pub. Date: Feb. 12, 2009

(54) ARRANGEMENT FOR OPERATING A GEOPHYSICAL LOCATING DEVICE

(76) Inventor: Andreas Krauss, Chemnitz (DE)

Correspondence Address: BODNER & O'ROURKE, LLP, 425 BROADHOLLOW ROAD, SUITE 108, MELVILLE, NY, 11747, US

(21) Appl. No.: 11/631,238

(22) PCT Filed: Jul. 1, 2005
(86) PCT No.: PCT/EP2005/007117

§ 371 Date: Sep. 18, 2008

(30) Foreign Application Priority Data
Jul. 2, 2004 (DE) 10 2004 032 234.1
Dec. 9, 2004 (DE) 10 2004 059 199.7

(51) Int. Cl. G01V 3/08

(52) U.S. Cl. 324/345

(57) ABSTRACT

The invention relates to an arrangement for operating a geophysical locating device by means of evaluating magnetic field changes, comprising flux gate sensors, an amplifying circuit as well as an evaluating and display unit.

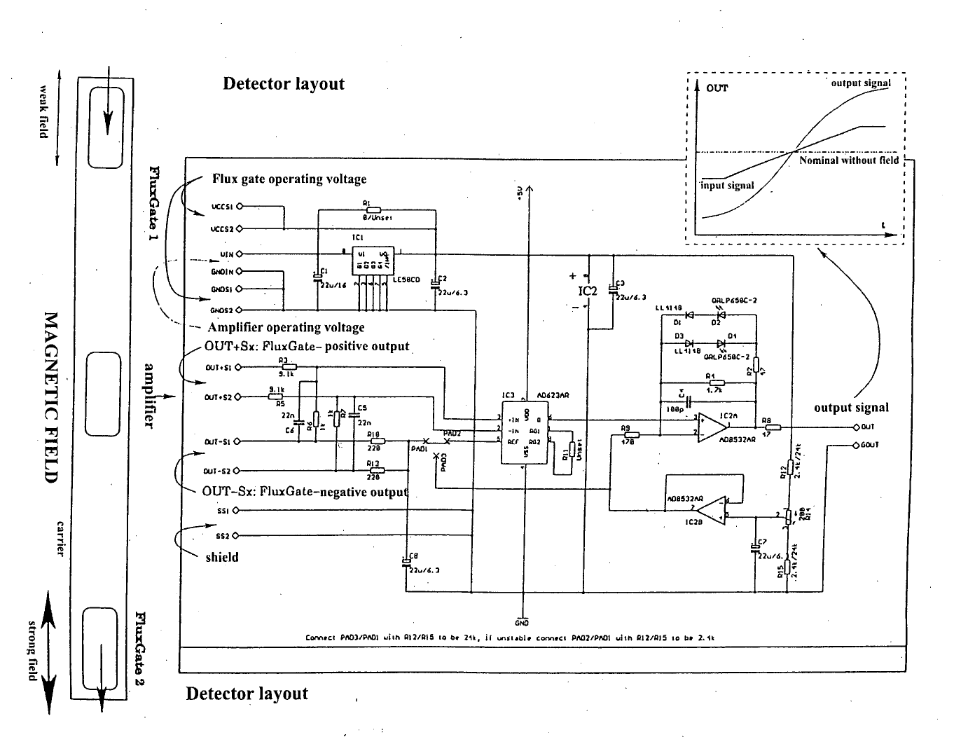

According to the invention, two interspaced flux gate sensors oriented in the same direction are provided in a probe, wherein the sensors furnish output voltages which are identical with regard to polarity.

The output signals are fed each to a level alignment circuit as well as to a low-pass filter. There is a connection to an input of a differential amplifier at the respective outputs of the low-pass circuits which is connected to the input of a limiting amplifier. The evaluation signal can be tapped at the output of the limiting amplifier for further processing.

The invention relates to an arrangement for operating a geophysical locating device by means of evaluating magnetic field changes, comprising flux gate sensors, an amplifying circuit as well as an evaluating and display unit in accordance with the precharacterizing portion of claim 1.

Geophysical locating devices based on detecting magnetic field changes or magnetic field anomalies are known in the prior art.

Such devices make use of a magnetic field-selective sensor mechanism, e.g. a flux gate, whereby the detected signal is amplified for purposes of evaluation and the amplified signals are transmitted to a display unit. When pacing off a certain search area, incoming signals are stored and processed per line or column in order to achieve a microprocessor-supported illustrative representation of the subsurface.

A substantial disadvantage in the case of simple flux gate signal amplification is that of an evaluable measurement only being able to occur given very small fields or field changes, this being due to the high amplification necessary when using such sensors. Should stronger magnetic fields be present, e.g. in the form of interference fields, there is the risk that the amplifier used will be overmodulated. This overmodulation then makes a field change, to be determined for the actual task of location, no longer detectable. An obvious possibility consists of designing the amplifier to be adjustable, although a result of this is that very small magnetic field changes will then no longer be resolved or only be resolved with great effort.

Given the above, the task which the present invention addresses is thus an improved arrangement for operating a geophysical locating device based on evaluating magnetic field changes, wherein the arrangement should be able, without requiring a complex gain control, to detect both considerable magnetic field gradients as well as small magnetic field changes for optimally detecting the location of objects both at shallow and at deeper depths.

The solution to this task of the invention is realized with an arrangement according to the feature combination of claim 1, whereby the subclaims contain at least functional embodiments and developments.

The arrangement according to the invention starts with the evaluation of a magnetic field difference, whereby two interspaced flux gate elements oriented in the same direction are used as sensors. Based on the arrangement of the flux gates in the same direction, they furnish polarity signs at the same output voltages, whereby the absolute value of the output voltage differs since magnetic field decreases with increasing distance.

The arrangement of the interspaced flux gate sensors oriented in the same direction, and that in a remote probe, and the use of a differential amplifier makes it possible to detect a change in the absolute strength of the magnetic field virtually independently of same, and this even when the magnetic field change itself is very small.

According to the invention, the output signals of the flux gate sensors are each fed to a level alignment circuit as well as to a low-pass filter, whereby at their output, the low-pass circuits are each transmitted to an input of the differential amplifier which in turn is connected to the input of a limiting amplifier.

The evaluation signal can then be tapped at the output of the limiting amplifier for further processing.

The flux gate sensors are preferably operated through a voltage stabilizing circuit.

A low-impedance reference voltage source, connected to the reference input of the differential amplifier, is provided for adjusting or calibrating the arrangement.

The connecting lines between the flux gate sensors and the input of the level alignment circuit are preferably shielded.

For optimum operation, the output signal without a magnetic field is set to approximately half of the operating voltage for the flux gate sensors.

One embodiment of the invention provides for a parallel circuit of a resistor and a group of diodes in the feedback branch of the limiting amplifier. The diode group consists of at least two antiparallel connected diodes.

An embodiment will be used in the following, as will reference to a FIGURE, in describing the invention in greater detail.

The FIGURE shows a circuit diagram indicating the arrangement of the flux gate sensors in the probe and diagramming a typical process of input and output signals.

In accordance with the representation at the left-hand side of the FIGURE, an interspaced arrangement is provided on a support comprising a flux gate 1 as well as a further flux gate 2. The vertical arrow representations at the left edge of the FIGURE symbolize first a weak and then a stronger magnetic field. The arrows depicted within the flux gates symbolize the detector orientation.

The output signals of both flux gate 1 and flux gate 2 are each transmitted to an input of an amplifying circuit.

This amplifying circuit initially spans a level alignment assembly as well as a low-pass circuit.

Specifically, the output signals of flux gate 1 and/or 2 connect to OUT+Sx and OUT−Sx. The OUT−Sx outputs furnish approximately half the operating voltage.

The combination of resistor R3 and R6 plus capacitor C6 and resistor R5, R7 and capacitor C5 form the above-mentioned level alignment circuit and filter out higher frequency signal components. The signal preprocessed in this manner is then led to input 2 or 3 of differential amplifier IC3.

The PADX circuit points and connections serve to set the output voltage for the entire amplifier in the absence of a field. PAD1 is usually connected to PAD2, whereby the output voltage without a field is set at approximately half of the operating voltage with potentiometer R14.

Circuit IC2B provides an appropriate low-impedance reference voltage.

Amplifier IC2A is configured as a limiting amplifier, whereby feedback ensues with diodes D1 to D4 together with resistors R2 and R4.

These measures ensure that low output voltages will be amplified more than higher voltages, whereby it is to be noted that the input voltage at IC2A already represents the difference of the flux gate output signals.

The output signal is tapped for further processing at OUT with reference to GOUT. Pins VCCSX and GNDSx are the operating voltage connections for the flux gates. VIN and GNDIN represent the operating voltage connections for the amplifier, whereby an optional stabilization is possible by means of circuit IC1. When the circuit is fitted with R1, stabilization would be omitted.

Connections SSx form the shields for the input leads to flux gate sensors 1 or 2 respectively.
The above-described circuit arrangement together with the probe comprising two interspaced flux gate sensors oriented in the same direction affords an effective and repeatable detection of magnetic field changes for locating purposes, and does so substantially independently of the magnitude to the magnetic field.

1. An arrangement for operating a geophysical locating device by means of evaluating magnetic field changes, comprising flux gate sensors, an amplifying circuit as well as an evaluating and display unit,
characterized in that
two interspaced flux gate sensors oriented in the same direction are provided in a probe, wherein the sensors furnish output voltages which are identical with regard to polarity,
the output signals are fed each to a level alignment circuit as well as to a low-pass filter,
the low-pass circuit outputs are each transmitted to an input of a differential amplifier which is connected to the input of a limiting amplifier,
wherein the evaluation signal can then be tapped at the output of the limiting amplifier for further processing.

2. The arrangement according to claim 1,
characterized in that
a stabilizing circuit is provided for supplying power to the flux gate sensors.

3. The arrangement according to claim 1,
characterized in that
a low-impedance reference voltage source can be connected to the reference input of the differential amplifier for calibrating the arrangement.

4. The arrangement according to claim 1,
characterized in that
the connecting lines between the flux gate sensors and the input of the level alignment circuit are shielded.

5. The arrangement according to claim 1,
characterized in that
the output signal without a magnetic field is set and calibrated to half of the operating voltage for the flux gate sensors.

6. The arrangement according to claim 1,
characterized in that
a parallel circuit of a resistor and a group of diodes is provided in the feedback branch of the limiting amplifier.

7. The arrangement according to claim 6,
characterized in that
the diode group consists of at least two antiparallel connected diodes.
